(19) United States
(12) Patent Application Publication
(10) Pub. No.: US 2024/0386597 A1
(43) Pub. Date: Nov. 21, 2024

(54) FUSION BETWEEN COMPUTER VISION OBJECT DETECTION AND RADAR OBJECT DETECTION

(71) Applicant: Iterate Studio, Inc., Highlands Ranch, CO (US)

(72) Inventors: Brainerd Sathianathan, Morgan Hill, CA (US); Arulkumaran Chandrasekaran, Sivakasi, Tamil Nadu (IN); Chatura Samarasinghe, San Jose, CA (US); Shomron Jacob, San Jose, CA (US)

(21) Appl. No.: 18/667,432

(22) Filed: May 17, 2024

Related U.S. Application Data
(60) Provisional application No. 63/503,094, filed on May 18, 2023.

(51) Int. Cl. G06T 7/70; G01S 13/86; G06V 10/764; G06V 20/52

(52) U.S. Cl. CPC G06T 7/70; G01S 13/867; G06V 10/764; G06V 20/52; G06T 2207/20084; G06V 2201/07

(57) ABSTRACT

Image data, such as a sequence of video frames, and radar data are received. The image data and the radar data correspond to a scene. Based on the image data, a target object may be detected within the scene and a first probability of the detected target object within the scene is determined. Based on the radar data, the target object may be detected within the scene and a second probability of the detected target object within the scene is determined. Based on the first probability and the second probability, a third probability of the detected target object within the scene is determined. A notification may be provided to at least one device based on the third probability.

### CROSS-REFERENCE TO RELATED APPLICATION(S)

This application claims priority to U.S. Provisional Application No. 63/503,094 titled “FUSION BETWEEN COMPUTER VISION OBJECT DETECTION AND RADAR OBJECT DETECTION” filed May 18, 2023. The aforementioned application is incorporated herein by reference, in its entirety, for any purpose.

### FIELD

The present disclosure relates generally to systems and methods for detecting objects using machine learning models.

### BACKGROUND

Conventionally, vision-based systems (e.g., images captured via a camera) may be employed for security purposes and crime prevention. However, vision based systems may be inherently limited in an ability to detect anomalous behavior or objects that are sufficiently concealed such that they are not visible to the naked eye. These limitations can lead to exploitable security gaps by bad actors.

### BRIEF DESCRIPTION OF THE DRAWINGS

Reference is now made to the following descriptions taken in conjunction with the accompanying drawings, in which:

FIG. 1 is depiction of a scene being monitored by a fusion object detection system in accordance with embodiments of the disclosure;

FIG. 2 is a schematic block diagram of a fusion object detection system in accordance with embodiments of the disclosure;

FIG. 3 is a schematic block diagram of a fusion object detection system in accordance with embodiments of the disclosure;

FIG. 4 is a flowchart of a method for detecting objects using vision and radar, in accordance with embodiments of the disclosure;

FIG. 5 is a flowchart of a method for training a model for detection of objects using vision and radar, in accordance with embodiments of the disclosure; and

FIG. 6 is a schematic diagram of an example computing system for implementing various embodiments in the examples described herein.

### DETAILED DESCRIPTION

The present application includes a system and a computer implemented method for using a combination of image data and radar data to identify or detect objects in a dynamic environment, such as a school, an airport, a stadium, or other public environment. As an example, the system may be used to assist security to detect dangerous objects, such as weapons, in a public space. The system may include a camera-based computer vision model and a radar-based point cloud model that each evaluate respective information from a scene, and that information is combined to determine whether a particular object is present. The computer vision model and the point cloud model may each include a respective machine learning (ML) architecture that are trained to automatically identify target objects in a scene.

The computer vision model may receive and evaluate streams of images (e.g., frames) from cameras feeds. The computer vision model may be trained on a series of models to detect various target objects (e.g., weapons, sharp objects, ski masks, etc.). The computer vision model may determine (e.g., classify) whether a particular video frame includes one of the targeted objects, and may generate a probability based on the detection. In some examples, the computer vision model may use a sequence of video frames to strengthen a probability prediction that a target object is present. In some examples, the computer vision model may evaluate every frame in the stream, or may evaluate a subset of frames (e.g., may drop some frames to reduce processing overhead). The number of frames dropped may be based on how dynamic the scene is and how many frames per second are being transmitted in the stream. In response to detection of one of the target objects, the computer vision model may also continue to detect additional objects to improve the detection probability.

One limitation of vision-based detection is that it requires line of sight to detect objects. Accordingly, to help compensate for this limitation, the system may further include a radar-based point cloud model that is trained to detect objects using radar-generated point cloud data generated by a radar sensor installed near the camera or cameras used by the computer vision model. A point cloud is a discrete set of data points in space. The point cloud model may be able to detect shapes of concealed objects by looking for arrangements of points in the point cloud data that form a shape of at least part of one or more target objects. The point cloud model may be trained to identify particular objects, whether they are concealed or not (e.g., the outline of a knife in someone's pocket). The point cloud model may provide a probability that a target object is detected.

The probabilities provided from each of the computer vision model and the point cloud model may be evaluated by a classifier that is trained to determine whether a target object has been detected in a scene. In addition, the computer vision model and the point cloud model may include an iterative feedback loop, where their respective probabilities output are fed back to each other. The computer vision model may use the information from the point cloud model to improve target object detection, and vice versa.

Certain details are set forth herein to provide an understanding of described embodiments of technology. However, other examples may be practiced without various ones of these particular details. In some instances, well-known computing system components, virtualization components, circuits, control signals, timing protocols, and/or software operations have not been shown in detail in order to avoid unnecessarily obscuring the described embodiments. Other embodiments may be utilized, and other changes may be made, without departing from the spirit or scope of the subject matter presented herein.

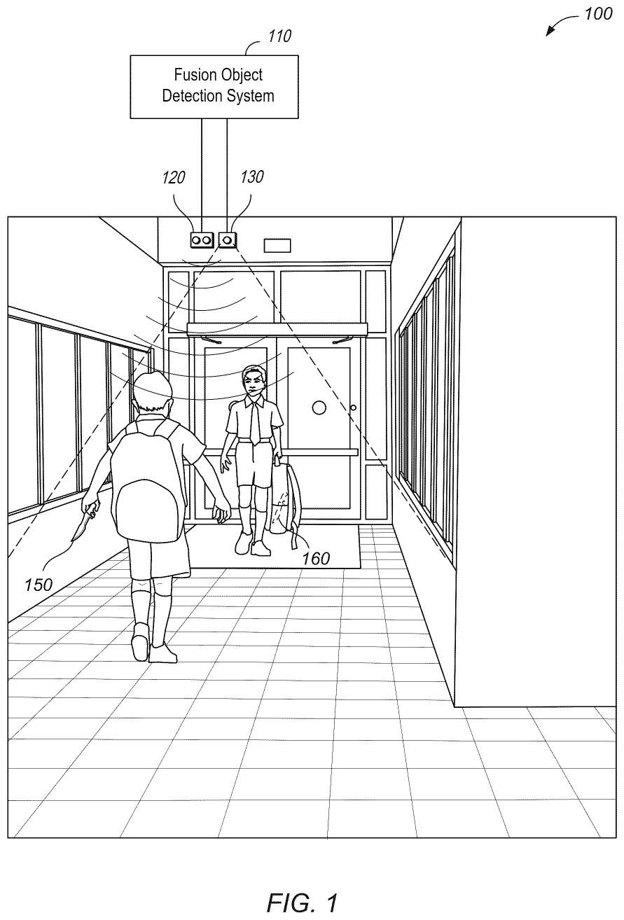

FIG. 1 is depiction of a scene 100 being monitored by a fusion object detection system 110 in accordance with embodiments of the disclosure. The scene 100 may include a hallway having two persons moving toward each other, such as in a school, an airport, a stadium, or other public space. One person is holding an object 150 and the other person has an object 160 concealed in their bag. The hallway may include a radar sensor 120 and a video camera 130 each configured to provide data to the fusion object detection system 110 based on the scene.

The fusion object detection system 110 may be configured to receive image data from the video camera 130 and point cloud data from the radar sensor 120, and may use a combination of the image data and the point cloud data to identify or detect objects (e.g., the object 150 and/or the object 160) in the scene 100. Generally speaking, the object detection system 110 may be capable of detecting any physical object or person, including objects or persons concealed or hidden behind another solid object. As examples, the object detection system 110 may be used to assist security to detect dangerous objects (concealed or non-concealed), such as weapons, a person or vehicle located in an unauthorized area, sharp objects, and ski masks. The objects may or may not be in a public space. The fusion object detection system 110 may include a camera-based computer vision model and a radar-based point cloud model that each evaluate respective information from the fusion object detection system 110, and that information may be combined to determine whether a particular object is present (e.g., the object 150 and/or the object 160). The computer vision model and the point cloud model may each include a respective machine learning (ML) architecture trained to automatically identify target objects in a scene.

The computer vision model may receive and evaluate streams of images (e.g., video frames) from the video camera 130. The computer vision model may be trained on a series of models to detect various target objects (e.g., the object 150 and the object 160). The computer vision model may determine (e.g., classify) whether a particular image (e.g., video frame) has one of the object 150 or the object 160, and may generate a probability based on the detection. In some examples, the computer vision model may use a sequence of video frames to strengthen a probability prediction that a target object is present. In some examples, the computer vision model may evaluate every frame in the stream from the video camera 130, or may evaluate a subset of frames (e.g., may drop some frames to reduce processing overhead) from the video camera 130.

The number of frames dropped may be based on how dynamic the scene 100 is and how many frames per second are being transmitted by the video camera 130. In response to detection of one of the target objects (e.g., the object 150 or the object 160), the computer vision model may also continue to detect additional objects to improve the detection probability.

However, because the object 160 is at least partially concealed in at bag, the vision-based detection of the computer vision model may be incapable of reliably detecting the object 160. Thus, the radar-based point cloud model may supplement the computer vision model. The point cloud model may be trained to detect objects using radar-generated point cloud data generated by the radar sensor 120 installed near the video camera 130. The point cloud model may be able to detect shapes of concealed (and non-concealed) objects (e.g., the object 160) by looking for arrangements of points in the point cloud data that form a shape of at least part of one or more target objects. The point cloud model may provide a probability that a target object is detected.

The probabilities provided from each of the computer vision model and the point cloud model may be evaluated by a classifier that is trained to determine whether a target object (e.g., the object 150 and the object 160) has been detected in the scene 100, and may provide a final probability based on that determination. In addition, the computer vision model and the point cloud model may include an iterative feedback loop, where their respective probabilities output are fed back to each other. The computer vision model may use the information from the point cloud model to improve target object detection, and vice versa.

In operation, the computer vision model of the fusion object detection system 110 may receive streams of images (e.g., video frames) from the video camera 130 and the point cloud model of the fusion object detection system 110 may receive point cloud data from the radar sensor 120 contemporaneously. The computer vision model may determine (e.g., classify) whether a particular video frame or a sequence of video frames has one of the object 150 or the object 160, and may generate a probability based on the detection. The computer vision model may also receive probability information (and other information, in some examples) from the point cloud model to aid in determining the probability that the object 150 and the object 160 are present in the scene 100.

The point cloud model may be trained to detect objects using radar-generated point cloud data generated by the radar sensor 120 installed near the video camera 130. In various examples, the radar sensor 120 and the video camera 130 may be installed such that the radar sensor 120 and the video camera 130 have substantially the same perspective of the scene 100 and/or the same or a similar field of view of the scene 100. The point cloud model may be able to detect shapes of concealed (and non-concealed) objects (e.g., the object 160) by looking for arrangements of points in the point cloud data that form a shape of at least part of one or more target objects. The point cloud model may also receive probability data (and other information, in some examples) from the computer vision model to further improve the probability determination that the object 150 and/or the object 160 is present in the scene 100.

The probabilities provided from each of the computer vision model and the point cloud model may be evaluated by a classifier that is trained to determine whether a target object (e.g., the object 150 and the object 160) has been detected in the scene 100, and may provide a final probability based on that determination. In some examples, the fusion object detection system 110 may include computer-readable media configured to store executable instructions that, when executed by one or more processors of the fusion object detection system 110, perform various operations of the computer vision model, the point cloud model, and/or the classifier.

It is appreciated that the scene 100 is exemplary, and is included for illustrative purposes, and that the fusion object detection system 110 may be implemented in any number of other scenes, both indoor and outdoor, without departing from the scope of the disclosure. While only one radar sensor 120 and one video camera 130 is included in FIG. 1, it is appreciated that the fusion object detection system 110 may be capable of receiving feeds from multiple radar sensors and video cameras without departing from the scope of the disclosure. Additionally or alternatively, the video camera 130 may be implemented as one or more still cameras that each capture a sequence of still images, or as a combination of at least one video camera and at least one still camera. Lastly, while the object 150 and the object 160 are both knives, it is appreciated that the fusion object detection system 110 can be trained to detect any other type of object without departing from the scope of the disclosure.

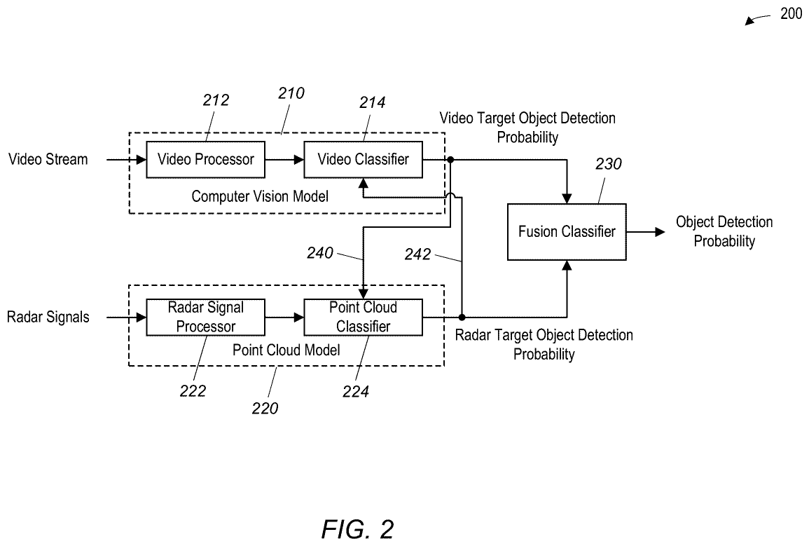

FIG. 2 is a schematic block diagram of a fusion object detection system 200 in accordance with embodiments of the disclosure. The fusion object detection system 200 may include a computer vision model 210 configured to receive a video stream from a camera (e.g., a video camera such as the video camera 130 in FIG. 1) and a point cloud model 220 configured to receive radar reflection data from a radar sensor (e.g., the radar sensor 120 in FIG. 1). The computer vision model 210 and the point cloud model 220 may each provide a target object detection probability to a fusion classifier 230, which may provide a final object detection probability. Thus, the fusion object detection system 200 may use a combination of the image data and the point cloud data to identify or detect objects in a scene (e.g., detect dangerous objects, such as weapons, in a public space). The fusion object detection system 110 of FIG. 1 may implement the fusion object detection system 200 in some examples.

The computer vision model 210 may include a video processor 212 and a video classifier 214. One or both of the video processor 212 and the video classifier 214 may include a respective machine learning (ML) architecture trained to perform respective functions. The video processor 212 may receive a video stream and may decode the video stream to provide sequences of image frames. The sequences of image frames may be provided to the video classifier 214. The video classifier 214 may be trained on a series of models detect various target objects. Accordingly, the video classifier 214 may receive and evaluate the sequence of video frames to determine (e.g., classify) whether a particular video frame or sequence of video frames has one or more target objects, and may generate a probability based on the detection. In some examples, the video classifier 214 may use a sequence of video frames to strengthen a probability prediction that a target object is present. In some examples, the video classifier 214 may evaluate every frame in the stream the video processor 212, or may evaluate a subset of frames (e.g., may drop some frames to reduce processing overhead) from the video processor 212. The number of frames dropped may be based on how dynamic the scene is and how many frames per second are being transmitted. For example, more frames may be dropped from a less dynamic scene and/or where more frames per second are transmitted to the computer vision model 210. In response to detection of one of the target objects the computer vision model 210 may also continue to detect additional objects to improve the detection probability.

The point cloud model 220 may supplement the computer vision model 210 in target object detection. The point cloud model 220 may include a radar signal processor 222 and a point cloud classifier 224. One or both of the radar signal processor 222 and the point cloud classifier 224 may include a respective machine learning (ML) architecture trained to perform respective functions. The radar signal processor 222 may be configured to receive radar reflection data from a radar sensor (such as the radar sensor 120 of FIG. 1) and may be configured to generate the point cloud data (depending on the data output from the radar sensor), or when the radar reflection data is point cloud data, process (e.g., extract and/or enhance (e.g., optimize)) the point cloud data for provision to the point cloud classifier 224. The point cloud classifier 224 may be trained to detect objects using the point cloud data generated by the radar signal processor 222. The point cloud classifier 224 may be able to detect shapes of concealed (and non-concealed) objects by looking for arrangements of points in the point cloud data that form a shape of at least a part of one or more target objects. The point cloud classifier 224 may provide a probability that a target object is detected. In some examples, the point cloud classifier 224 may be trained to detect particular types of objects (e.g., weapons or particular types of weapons) which are more likely to be present in the environment.

The probabilities provided from each of the computer vision model 210 and the point cloud model 220 may be evaluated by a fusion classifier 230 that is trained to determine whether a target object has been detected in a scene. The fusion classifier 230 may provide a final probability based on that determination. The fusion classifier 230 may include a respective machine learning (ML) architecture trained to perform respective functions of the fusion classifier 230. In addition, the computer vision model 210 and the point cloud model 220 may include one or more iterative feedback loops, where the respective probabilities output by the computer vision model 210 and the point cloud model 220 are fed back to each other. In the illustrated embodiment, a first feedback path 240 is between an output of the video classifier 214 and the point cloud classifier 224. The first feedback path 240 provides the probability output from the video classifier 214 to the point cloud classifier 224. A second feedback path 242 is between an output of the point cloud classifier 224 and the video classifier 214. The second feedback path 242 provides the probability output from the point cloud classifier 224 to the video classifier 214. The computer vision model 210 may use the information from the point cloud model 220 to improve target object detection, and vice versa.

In operation, the computer vision model 210 may receive a video stream from a camera (e.g., the video camera 130 of FIG. 1) and the point cloud model 220 may receive radar reflection data from a radar sensor (e.g., the radar sensor 120 of FIG. 1), contemporaneously. The video processor 212 of the computer vision model 210 may generate a sequence of video frames, and the video classifier 214 may determine (e.g., classify) whether the sequence of video frames has one or more target objects, and may generate a probability based on the detection. The computer vision model 210 may also receive probability information (and other information, in some examples) from the point cloud model 220 via the feedback loop 242 to aid in determining the probability that any target objects are present in the scene.

The radar signal processor 222 may be configured to generate the point cloud data (depending on the data output from the radar sensor), or when the radar reflection data is point cloud data, process (e.g., extract and/or enhance (e.g., optimize)) the point cloud data and the point cloud classifier 224 may be trained to detect objects using the point cloud data. The point cloud classifier 224 may be able to detect shapes of concealed (and non-concealed) objects by looking for arrangements of points in the point cloud data that form a shape of at least a part of one or more target objects. The point cloud model 220 may also receive probability data (and other information, in some examples) from the computer vision model 210 via the feedback loop 240 to further improve the probability determination that a target object is present in a scene.

The probabilities provided from each of the video classifier 214 and the point cloud classifier 224 may be evaluated by the fusion classifier 230 that is trained to determine whether a target object has been detected in the scene. The fusion classifier 230 may be configured to generate a final probability that a target object is detected in the scene based on a comparison between the output of the video classifier 214 and the output of the point cloud classifier 224. In some examples, the fusion object detection system 200 may include computer-readable media configured to store executable instructions that, when executed by a one or more processors of the fusion object detection system 200, may cause the fusion object detection system 200 to perform various operations of the computer vision model 210, the point cloud model 220, and/or the fusion classifier 230.

While the video processor 212 and the radar signal processor 222 are shown as being part of the computer vision model 210 and the point cloud model 220, respectively, it is appreciated that the video processor 212 and the radar signal processor 222 may be part of the camera or the radar sensor, respectively, without departing from the scope of the disclosure.

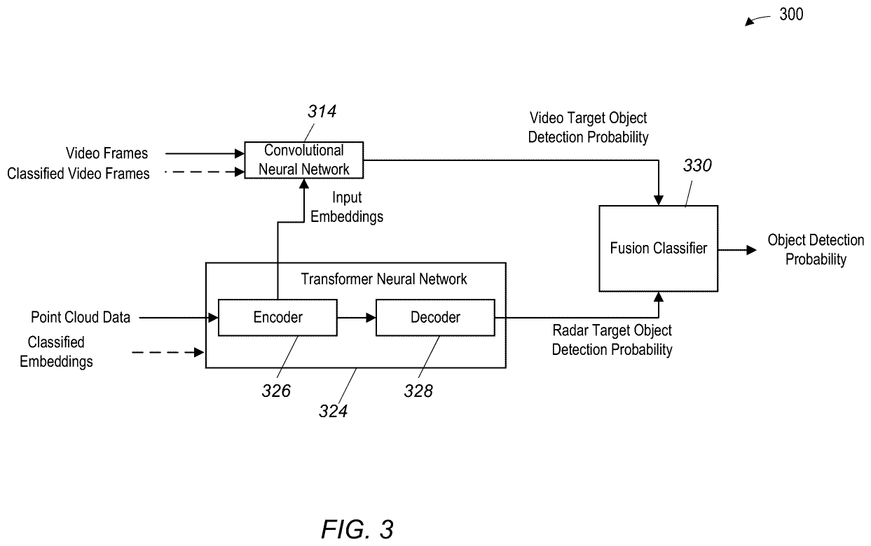

FIG. 3 is a schematic block diagram of a fusion object detection system 300 in accordance with embodiments of the disclosure. The fusion object detection system 300 may include a convolutional neural network 314 configured to receive a sequence of video frames and a transformer neural network 324 configured to receive point cloud data. During training, the convolutional neural network 314 may be configured to receive classified video frames and/or classified embeddings data, and the transformer neural network 324 may be configured to receive classified embeddings data. The convolutional neural network 314 and the transformer neural network 324 may each provide a target object detection probability to a fusion classifier 330, which may provide a final object detection probability. Thus, the fusion object detection system 300 may use a combination of the image data and the point cloud data to identify or detect objects in a scene (e.g., detect dangerous objects, such as weapons, in a public space). The fusion object detection system 110 of FIG. 1 and/or the fusion object detection system 200 of FIG. 2 may implement the fusion object detection system 300, in some examples.

The convolutional neural network 314 may include a multi-layer neural network that uses convolution (e.g., rather than general matrix multiplication) in at least one layer to evaluate received information. In some examples, the convolutional neural network 314 may be designed and trained to process pixel data for use in image recognition and processing of the sequence of video frames. The trained convolutional neural network 314 may receive and evaluate the sequence of video frames to determine (e.g., classify) whether a particular image frame or sequence of video frames has one or more target objects, and may generate a probability based on the detection.

The convolutional neural network 314 may supplement the transformer neural network 324 in target object detection by detecting target objects using point cloud data. The transformer neural network 324 may include a deep learning model that adopts a mechanism of self-attention, differentially weighting the significance of each part of the point cloud data. Like recurrent neural networks (RNNs), the transformer neural network 324 may be designed to process sequential input data. However, unlike RNNs, the transformer neural network 324 may process the entire point cloud data input all at once, which may reduce training time and may prevent the loss (e.g., forgetting) of earlier information in a long sequence of point cloud data as compared with an RNN. The transformer neural network 324 may include an encoder 326 that encodes the point cloud data to produce input embeddings data, and a decoder 328 that decodes the input embeddings data to determine object detection probability. The input embeddings data from the transformer neural network 324 may be provided to the convolutional neural network 314, and the convolutional neural network 314 may use the input embeddings data to assist in generating the target object detection probability.

The convolutional neural network 314 and the transformer neural network 324 may be trained at the same time by providing classified video frames and classified embeddings data to the convolutional neural network 314 and the transformer neural network 324, respectively. The transformer neural network 324 may include a generative adversarial network (GAN) to train the transformer neural network 324 using point cloud data and classified transformer embeddings data.

In the GANs, the classified transformer embeddings data are compared with input embeddings data generated by the encoder 326 by a discriminator, and the discriminator determines whether the generated input embeddings data are distinguishable from the classified transformer embeddings data. In some examples, the GANs may select the classified embeddings for provision to the convolutional neural network 314 in response to detection that the input embeddings data is incorrect. When the generated input embeddings data become sufficiently (e.g., statistically) indistinguishable from the classified embeddings data, the transformer neural network 324 may be sufficiently trained.

Contemporaneously, the convolutional neural network 314 may receive a selected one of the input embeddings data or the classified embeddings data from the encoder 326, along with the classified video frames, and may iteratively train using the input embeddings data or the classified embeddings data and the classified video data using a form of stable diffusion, where the input embeddings data or the classified embeddings data are converted to image data using the classified frame data to train the convolutional neural network 314. Because the convolutional neural network 314 and the transformer neural network 324 are being trained contemporaneously, the time it takes to train may be reduced as compared with sequentially training the convolutional neural network 314 and the transformer neural network 324.

The probabilities provided from each of the convolutional neural network 314 and the transformer neural network 324 may be evaluated by the fusion classifier 330 that is trained to determine whether a target object has been detected in a scene, and may provide a final probability based on that determination. In some examples, the fusion classifier 330 may be trained at the same time as the convolutional neural network 314 and the transformer neural network 324 (e.g., and/or may be combined with the convolutional neural network 314) to improve efficiency of the fusion object detection system 300.

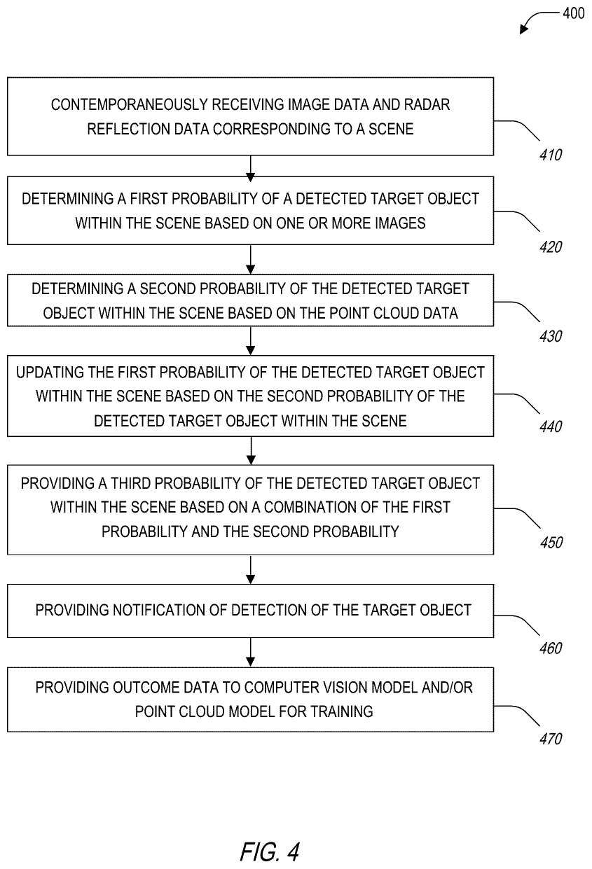

FIG. 4 is a flowchart of a method 400 for detecting objects using vision and radar, in accordance with embodiments of the disclosure. The method 400 may be performed by the fusion object detection system 110 of FIG. 1, the fusion object detection system 200 of FIG. 2, the fusion object detection system 300 of FIG. 3, or any combination thereof.

The method 400 may include contemporaneously receiving image data and radar reflection data corresponding to a scene, at 410. The image data may be a sequence of video frames or a sequence of still images, both of which are referred to as “a sequence of images”, and the radar reflection data can be point cloud data or other radar data. When other radar data is received, the other radar data may be converted or transformed into point cloud data. In some examples, the scene is a public space and the target object is a weapon. In some examples, the target object is at least partially concealed.

The method 400 may include determining a first probability of a detected target object within the scene based on the sequence of images, at 420. In some examples, the method 400 may include processing the sequence of images to determine the first probability of the detected target object within the scene using a computer vision machine learning model (e.g., the computer vision model 210 of FIG. 2 or the convolutional neural network 314 of FIG. 3). In some examples, the method 400 may include processing the sequence of images to determine the first probability of the detected target object within the scene using a convolutional neural network.

The method 400 may include determining a second probability of the detected target object within the scene based on the point cloud data, at 430. In some examples, the method 400 may include processing the point cloud data to determine the second probability of the detected target object within the scene using a transformer machine learning model (e.g., the transformer neural network 324 of FIG. 3). In some examples, the method 400 may further include generating, at the transformer machine learning model, the embeddings data based on the point cloud data. In some examples, the method 400 may further include generating, at the transformer machine learning model, the embeddings data based on the point cloud data, and generating the second probability based on the embeddings data.

The method 400 may include updating the first probability of the detected target object within the scene based on the second probability of the detected target object within the scene, at 440. In some examples, the method 400 may further include updating the first probability of the detected target object within the scene based on the embeddings data generated by the transformer machine learning model based on the point cloud data.

The method 400 may include providing a third probability of the detected target object within the scene based on a combination of the first probability and the second probability, at 450. Based on the third probability, a determination may be made as to whether the target object is detected. In some implementations, the determination as to whether the target object is detected may be based on the third probability equaling or exceeding a threshold probability value. Alternatively, the determination as to whether the target object is detected can be based on the third probability falling within a range of probability values, where the minimum probability value is equivalent to a threshold probability value. Different metrics can be used to determine whether the target object is detected in other embodiments.

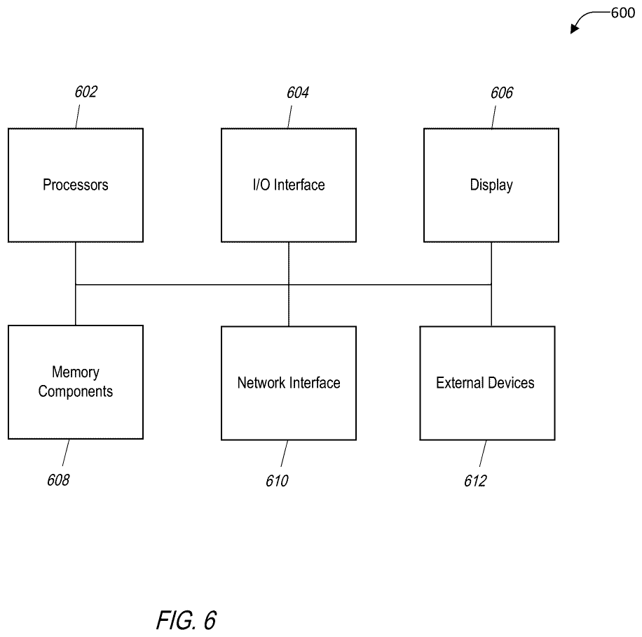

When a determination is made that the target object is detected, one or more notifications are provided to at least one device, at 460. The fusion object detection system 110 of FIG. 1, the fusion object detection system 200 of FIG. 2, the fusion object detection system 300 of FIG. 3, or any combination thereof, a computing system executing some or all of the fusion object detection system 110 of FIG. 1, the fusion object detection system 200 of FIG. 2, the fusion object detection system 300 of FIG. 3, or any combination thereof, and/or a computing device (e.g., the computing system shown in FIG. 6) in communication with such systems may be configured to generate and transmit a notification to at least one device (e.g., an external device such as external device 612 in FIG. 6). The computing device may be in communication with such systems via a communication network, such as a wired or wireless network. Example devices that can be configured to receive notifications include, but are not limited to, a computer, a laptop, a tablet, a cellular telephone, a wearable device, a television, an automobile, and a speaker or speakers. The notifications may be visual notifications, audible notifications, tactile notifications, and any combination thereof.

For example, when a fusion detection system disclosed herein detects a target object, and the target object is a weapon, a text message or email message may be sent to one or more devices (e.g., cellular telephone, tablet). Additionally or alternatively, an alert message can be transmitted to and output on a speaker at the one or more devices and/or displayed on a display screen (e.g., a laptop, a television, a screen in an automobile). An alarm can be triggered using a speaker system (e.g., one or more speakers) at the location or in a security control room, and/or haptic feedback may be provided on one or more wearable devices. As discussed previously, the target object can be any object. Additional example target objects include, but are not limited to, a recording device at an entertainment event, a person or a vehicle at an unauthorized location, sharp objects, and ski masks.

Outcome data may be provided to a fusion detection system, such as a computer vision model and/or a point cloud model disclosed herein, for additional training (at 470). The outcome data can indicate an accuracy of the first probability, the second probability, and/or the third probability. The additional training may fine-tune or improve the efficiency and/or the accuracy of the fusion detection system. For example, when a fusion detection system determines a target object is detected, and that determination is false, the outcome data can be included in one or more training datasets to further train the fusion detection system. Similarly, when a fusion detection system determines a target object is detected, and that determination is true, the outcome data can be included in one or more training datasets to further train (e.g., reinforce) the fusion detection system.

Although FIG. 4 depicts the operations of the method in a particular order, other embodiments can omit an operation or perform some of the operations in parallel rather than in series. For example, the operations of 420 and 430 and/or the operations of 460 and 470 may be performed in parallel. Additionally or alternatively, the operation 470 can be omitted in other implementations.

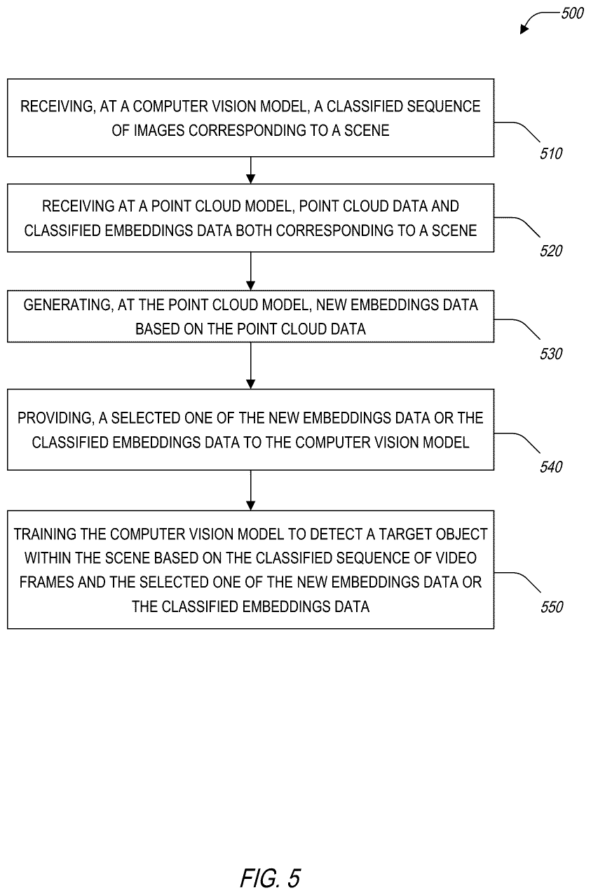

FIG. 5 is a flowchart of a method 500 for training a model for detection of objects using vision and radar, in accordance with embodiments of the disclosure. The method 500 may be performed by the fusion object detection system 110 of FIG. 1, the fusion object detection system 200 of FIG. 2, the fusion object detection system 300 of FIG. 3, or any combination thereof.

The method 500 may include receiving, at a computer vision model, a classified sequence of images (e.g., video frames or still images) corresponding to a scene, at 510. In some examples, the scene is a public space and the target object is a weapon. In some examples, the target object is at least partially concealed.

The method 500 may include receiving, at a point cloud model, radar data or point cloud data and classified embeddings data both corresponding to the scene, at 520. When radar data is received, the radar data may be converted or transformed into point cloud data. In some examples, the method 500 may include processing the sequence of images to determine the first probability of the detected target object within the scene using a computer vision machine learning model (e.g., the computer vision model 210 of FIG. 2 or the convolutional neural network 314 of FIG. 3). In some examples, the method 500 may include processing the sequence of images to determine the first probability of the detected target object within the scene using a convolutional neural network.

The method 500 may include generating, at the point cloud model, new embeddings data based on the point cloud data, at 530. In some examples, the method 500 may include processing the point cloud data to determine the second probability of the detected target object within the scene using a transformer machine learning model (e.g., the transformer neural network 324 of FIG. 3). In some examples, the method 500 may further include generating, at the transformer machine learning model, the embeddings data based on the point cloud data. In some examples, the method 500 may further include generating, at the transformer machine learning model, the embeddings data based on the point cloud data, and generating the second probability based on the embeddings data.

The method 500 may include providing, a selected one of the new embeddings data or the classified embeddings data to the computer vision model, at 540. In some examples, the method 500 may further include selecting, at a generative adversarial network of the point cloud model, the one of the new embeddings data or the classified embeddings data based on a comparison between the new embeddings data or the classified embeddings data.

The method 500 may include training the computer vision model to detect a target object within the scene based on the classified sequence of video frames and the selected one of the new embeddings data or the classified embeddings data, at 550. In some examples, the method 500 may include training the point cloud model to detect the target object within the scene based on a comparison between the new embeddings data and the classified embeddings data. For example, the method 500 may further include updating the point cloud model based on selection of the classified embeddings data.

FIG. 6 is a schematic diagram of an example computing system 600 for implementing various embodiments in the examples described herein. Computing system 600 may be used to implement the fusion object detection system 110 of FIG. 1, the fusion object detection system 200 of FIG. 2, and/or the fusion object detection system 300 of FIG. 3, or it may be integrated into one or more of the components of the fusion object detection system 110 of FIG. 1, the fusion object detection system 200 of FIG. 2, and/or the fusion object detection system 300 of FIG. 3. The computing system 600 may be used to implement or execute one or more of the components or operations disclosed in FIGS. 1-5. The computing system 600 may include one or more processors 602, an input/output (I/O) interface 604, a display 606, one or more memory components 608, a network interface 610, and one or more external devices 612. Each of the various components may be in communication with one another through one or more buses or communication networks, such as wired or wireless networks.

The one or more processors 602 may be implemented using generally any type of electronic device capable of processing, receiving, and/or transmitting instructions. For example, the processor(s) 602 may include or be implemented by a central processing unit, microprocessor, processor, microcontroller, or programmable logic components (e.g., FPGAs).

Additionally, it should be noted that some components of the computing system 600 may be controlled by a first processor and other components may be controlled by a second processor, where the first and the second processors may or may not be in communication with each other.

The one or more memory components 608 may be used by the computing system 600 to store instructions, such as executable instructions discussed herein, for the one or more processors 602, as well as to store data, such as dataset data, machine learned model data, and the like. The memory component(s) 608 may be, for example, magneto-optical storage, read-only memory, random access memory, erasable programmable memory, flash memory, or a combination of one or more types of memory components.

The display 606 provides a trained machine learned model, an output of a machine learned model after running an evaluation set, or relevant outputs and/or data, to a user of the fusion object detection system 110 of FIG. 1, the fusion object detection system 200 of FIG. 2, the fusion object detection system 300 of FIG. 3, or a user of a user device described herein (not shown). Optionally, the display 606 may act as an input element to enable a user of the fusion object detection system 110 of FIG. 1, the fusion object detection system 200 of FIG. 2, and/or the fusion object detection system 300 of FIG. 3 to manually alter the data used in the training and/or evaluating, the model trained, or the predicted output of the model, or any other component in the fusion object detection system 110 of FIG. 1, the fusion object detection system 200 of FIG. 2, and/or the fusion object detection system 300 of FIG. 3 as described in the present disclosure. The display 606 may be a liquid crystal display, plasma display, organic light-emitting diode display, and/or other suitable display. In embodiments where the display 606 is used as an input, the display 606 may include one or more touch or input sensors, such as capacitive touch sensors, a resistive grid, or the like.

The I/O interface 604 allows a user to enter data into the computing system 600, as well as provides an input/output for the computing system 600 to communicate with other devices or services, the fusion object detection system 110 of FIG. 1, the fusion object detection system 200 of FIG. 2, and/or the fusion object detection system 300 of FIG. 3 and other computing devices (not shown). The I/O interface 604 can include one or more input buttons, touch pads, track pads, mice, keyboards, audio inputs (e.g., microphones), audio outputs (e.g., speakers), and so on.

The network interface 610 provides communication to and from the computing system 600 to other devices. For example, the network interface 610 may allow the fusion object detection system 110 of FIG. 1, the fusion object detection system 200 of FIG. 2, and/or the fusion object detection system 300 of FIG. 3 to communicate with the radar sensor 120 and/or the video camera 130 of FIG. 1 or other devices (not shown) through a communication network.

The network interface 610 includes one or more communication protocols, such as, but not limited to Wi-Fi, ETHERNET@, BLUETOOTH®, cellular data networks, and so on. The network interface 610 may also include one or more hardwired components, such as a Universal Serial Bus (USB) cable, or the like. The configuration of the network interface 610 depends on the types of communication desired and may be modified to communicate via Wi-Fi, BLUETOOTH®, and so on.

The one or more external devices 612 are one or more devices that can be used to provide various inputs to the computing system 600, such as a mouse, a microphone, a keyboard, a trackpad, or the like. The external device(s) 612 are also one or more devices that can be used to provide various outputs from the computing system 600, such as a printer, a speaker or speakers, a storage device, another computing system, and the like. The one or more external devices 612 may be local or remote and may vary as desired. In some examples, the one or more external devices 612 may also include one or more additional sensors.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A computer implemented method, comprising:
contemporaneously receiving a sequence of images and point cloud data corresponding to a scene, the sequence of images received from a camera and the point cloud data received from a radar sensor;
determining, at a computer vision machine learning model, a first probability of a detected target object within the scene based on at least one image in the sequence of images;
determining, at a point cloud machine learning model, a second probability of the detected target object within the scene based on the point cloud data;
determining, at a fusion classifier, a third probability of the detected target object within the scene based on the first probability and the second probability; and
providing a notification to a device based on the third probability exceeding a threshold probability value.

2. The computer implemented method of claim 1, further comprising:
updating the first probability of the detected target object within the scene based on the second probability of the detected target object within the scene; and
updating the second probability of the detected target object within the scene based on the first probability of the detected target object within the scene.

3. The computer implemented method of claim 2, wherein updating the first probability of the detected target object within the scene based on the second probability of the detected target object within the scene comprises updating the first probability of the detected target object within the scene based on embeddings data generated at the point cloud machine learning model.

4. The computer implemented method of claim 1, further comprising processing, at the computer vision machine learning model, the sequence of images to determine the first probability of the detected target object within the scene.

5. The computer implemented method of claim 1, further comprising processing, at the cloud point machine learning model, the point cloud data to determine the second probability of the detected target object within the scene.

6. The computer implemented method of claim 1, wherein the scene is a public space and the target object is a weapon.

7. The computer implemented method of claim 1, wherein the target object is at least partially concealed.

8. The computer implemented method of claim 1, wherein:
the camera comprises a video camera; and
the sequence of images comprises a sequence of video frames.

9. The computer implemented method of claim 1, wherein:
the computer vision machine learning model comprises a video processor connected to a video classifier;
the video processor receives the sequence of images and generates a sequence of image frames;
the video classifier receives the sequence of image frames and generates the first probability based on at least one image frame in the sequence of image frames;
the point cloud machine learning model comprises a radar signal processor connected to a point cloud classifier;
the radar signal processor receives the point cloud data and process the point cloud data; and
the point cloud classifier receives the point cloud data and generates the second probability based on the point cloud data.

10. The computer implemented method of claim 1, wherein the device comprises at least one of:
a laptop;
a tablet;
a display;
a cellular telephone;
a wearable device; or
a television.

11. A system, comprising:
a camera configured to provide a sequence of images of a scene;
a radar sensor configured to provide point cloud data of the scene;
one or more memories storing executable instructions; and
one or more processors each configured to execute the executable instructions to cause operations to be performed, the operations comprising:
generating a sequence of image frames based on received sequence of images;
determining a first probability of a detected target object within the scene based on at least one image frame in the sequence of image frames;
determining a second probability of the detected target object within the scene based on the point cloud data;
determining a third probability of the detected target object within the scene based on the first probability and the second probability; and
providing a notification based on the third probability exceeding a threshold probability value.

12. The system of claim 11, wherein:
the received sequence of images is received at a video processor of a computer vision machine learning model, the video processor configured to decode the received sequence of images into the sequence of image frames;
the received point cloud data is received at a radar signal processor of a point cloud machine learning model, the radar signal processor configured to process the point cloud data;
the first probability is determined at a video classifier of the computer vision machine learning model, the video classifier configured to detect a target object based on an evaluation of the sequence of image frames and generate the first probability; and
the second probability is determined at a point cloud classifier of the point cloud machine learning model, the point cloud classifier configured to detect the target object based on an evaluation of the point cloud data and generate the second probability.

13. The system of claim 12, further comprising:
a first feedback path between an output of the video classifier and the point cloud classifier; and
a second feedback path between an output of the point cloud classifier and the video classifier.

14. The system of claim 11, wherein:
the received sequence of images is received at a convolutional neural network, the convolutional neural network configured to determine the first probability based on the sequence of images;
the received point cloud data is received at an encoder of a transformer neural network, the encoder configured to encode the received point cloud data to produce input embeddings data; and
the input embeddings data is received at a decoder of the transformer neural network, the decoder configured to decode the input embeddings data to determine the second probability.

15. The system of claim 11, wherein a fusion classifier is configured to receive the first probability and the second probability and determine the third probability based on the first probability and the second probability.

16. The system of claim 15, wherein the fusion classifier is configured to compare the first probability and the second probability to determine the third probability.

17. A computer implemented method, comprising:
receiving, at a convolutional neural network, a plurality of video frames corresponding to a scene;
receiving at a transformer neural network, point cloud data corresponding to the scene;
determining, at the convolutional neural network, a first probability of a detected target object within the scene based on the plurality of video frames;
generating, at the transformer neural network, embeddings data based on the point cloud data;
generating, at the transformer neural network, a second probability of the detected target object within the scene based on the embeddings data;
generating, at a classifier, a third probability of the detected target object within the scene based on the first probability and the second probability; and
providing a notification based on the third probability exceeding a threshold probability value.

18. The computer implemented method of claim 17, further comprising providing the embeddings data to the convolutional neural network.

19. The computer implemented method of claim 17, further comprising providing outcome data to at least one of the convolutional neural network or the transformer neural network for training, the outcome data indicating an accuracy of the first probability or the second probability.

20. The computer implemented method of claim 17, wherein the notification is provided to a device, the device comprising at least one of:
a laptop;
a tablet;
a display;
a cellular telephone;
a wearable device; or
a television.
